(19) United States
(12) Patent Application Publication
(10) Pub. No.: US 2023/0200354 A1
(43) Pub. Date: Jun. 29, 2023

(54) Dog Harness Assembly

(71) Applicant: Jeffrey Allen Gilmore, MInnetonka, MN (US)

(72) Inventor: Jeffrey Allen Gilmore, MInnetonka, MN (US)

(21) Appl. No.: 17/560,848

(22) Filed: Dec. 23, 2021

(51) Int. Cl. A01K 27/00

(52) U.S. Cl. CPC A01K 27/002

(57) ABSTRACT

A dog harness assembly includes a chest section that has a front edge and a rear edge. A stomach section is attached to the rear edge of the chest section. A back section has a forward end and a rearward end. A coupler attaches the chest and back sections to each other and includes an opening to receive a head of the dog. A connector secures the stomach section to the back section. A control strap includes a first strap section and a second strap section each having a first end attached to the chest section. A loop is attached to the first and second strap sections distal to the first ends. A pair of guides is attached to the back section. Each of the guides receives one of the strap sections. The front edge is pulled toward the forward end when the loop is pulled rearward.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to harness devices and more particularly pertains to a new harness device for providing control to a handler of a dog while preventing injury to any portion, and in particular to a neck area, of the dog. The harness of the present invention provides for compression against a dog's chest area while also producing pressure against the dog's neck area. Together, these forces provide greater control over the dog by the handler while ensuring that excessive force is not applied in a concentrated area leading to injury. This allows the handler to prevent the dog from continuous pulling on a leash without fear of damaging areas of the dog's neck.

### (2) Description of Related Art Including Information Disclosed Under 37 CFR 1.97 and 1.98

The prior art relates to harness devices and other restraint devices typically used by dog handlers. These devices usually are provided either a harness which provides a handler leverage when physically restraining a dog and collars having various choking and pinching characteristics used for subduing a dog from aggressive actions and continuously pulling on a leash. While generally effective for their intended respective uses, harnesses do not prevent a dog from continued pulling on the leash while collars can injury the neck of a dog having a tendency to continuously pull on the leash.

### (h) BRIEF SUMMARY OF THE INVENTION

An embodiment of the disclosure meets the needs presented above by generally comprising a chest section, for positioning on a chest of the dog, having a front edge, a rear edge and a pair of lateral edges. A stomach section for positioning on a stomach of the dog is attached to the rear edge of the chest section. A back section positionable on a back of the dog has a forward end, a rearward end, and a pair of side edges. A coupler extends between and attaches the chest and back sections to each other. The coupler includes an opening positioned between the front edge and the forward end to receive a head of the dog such that the front edge is adjacent to a front of a neck of the dog and the forward end is adjacent to a backside of the neck of the dog. A connector secures the stomach section to the back section. A control strap includes a first strap section and a second strap section. Each of the first and second strap sections has a first end attached to the chest section. The first ends are positioned adjacent to the front edge and are spaced from each other such that the neck of the dog is positioned between the first and second strap sections. A loop is attached to the first and second strap sections distal to the first ends. A pair of guides is attached to the back section adjacent to forward end and are laterally spaced from each other. Each of the guides has one of the strap sections movably extending therethrough. The front edge is pulled toward the forward end when the loop is pulled rearward of the back section.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a dog harness assembly according to an embodiment of the disclosure.

FIG. 2 is a bottom view of an embodiment of the disclosure.

FIG. 3 is a top view of an embodiment of the disclosure having a control strap thereof removed.

FIG. 4 is a top isometric view of an embodiment of the disclosure.

FIG. 5 is a top isometric view of an embodiment of the disclosure.

FIG. 6 is a front isometric in-use view of an embodiment of the disclosure.

FIG. 7 is a side in-view of an embodiment of the disclosure.

### (j) DETAILED DESCRIPTION OF THE INVENTION

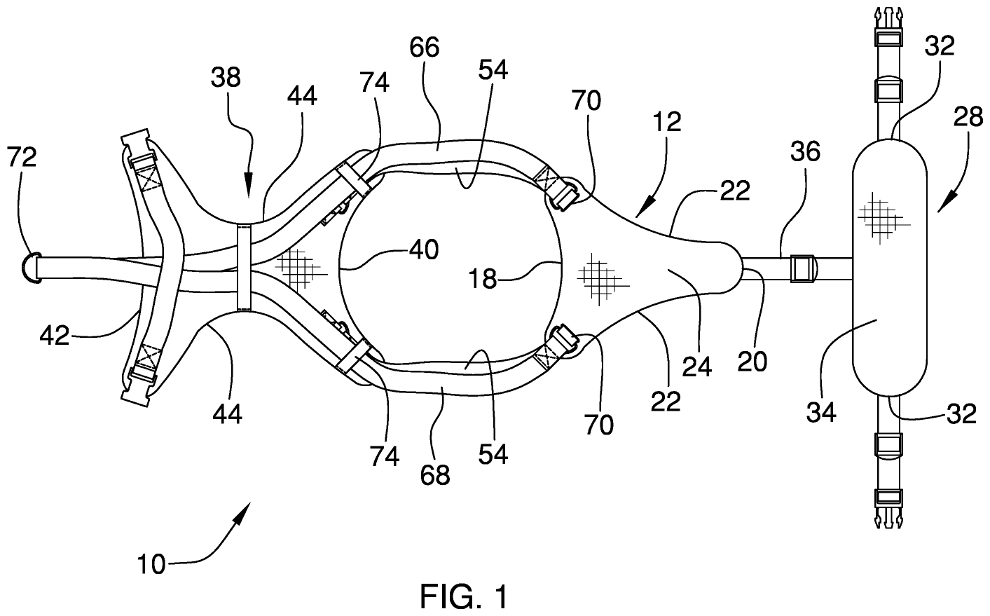

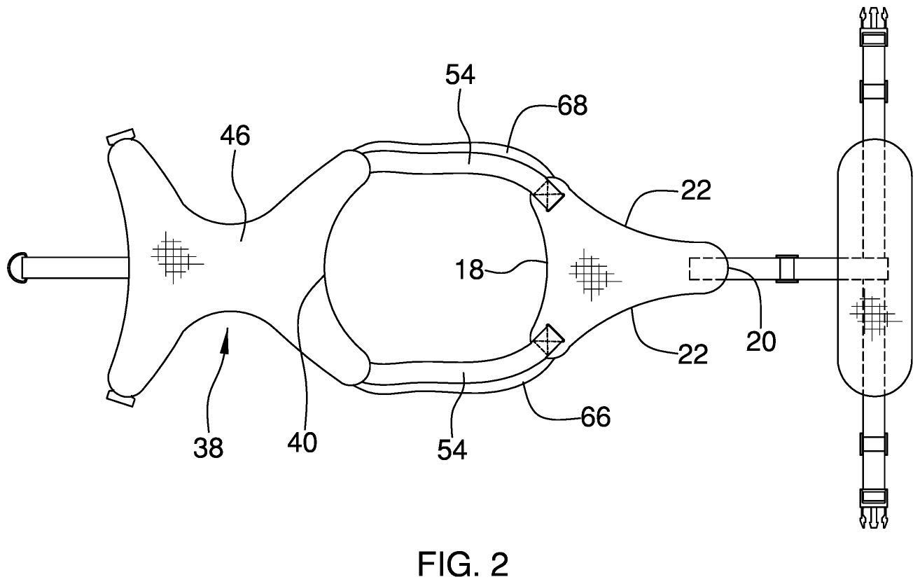

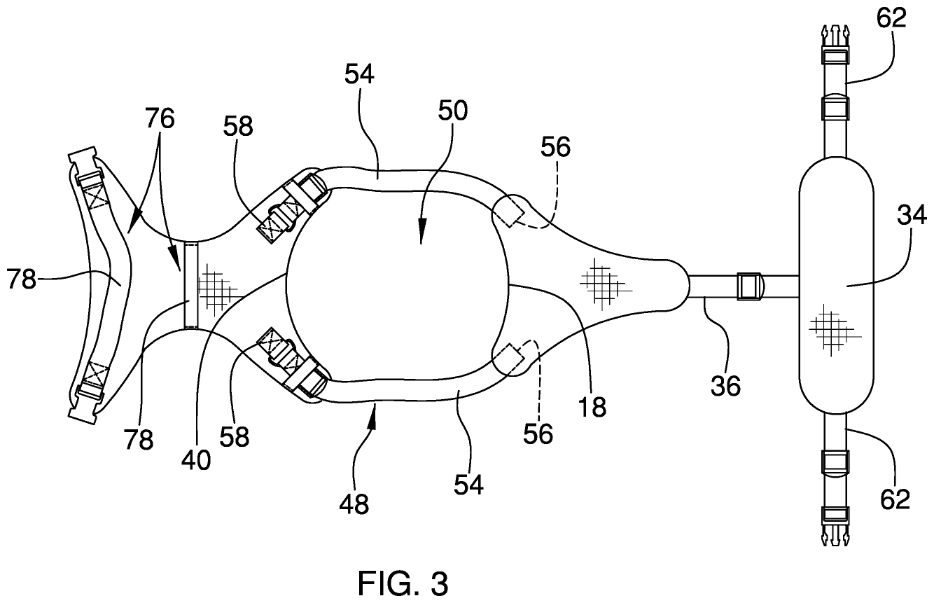

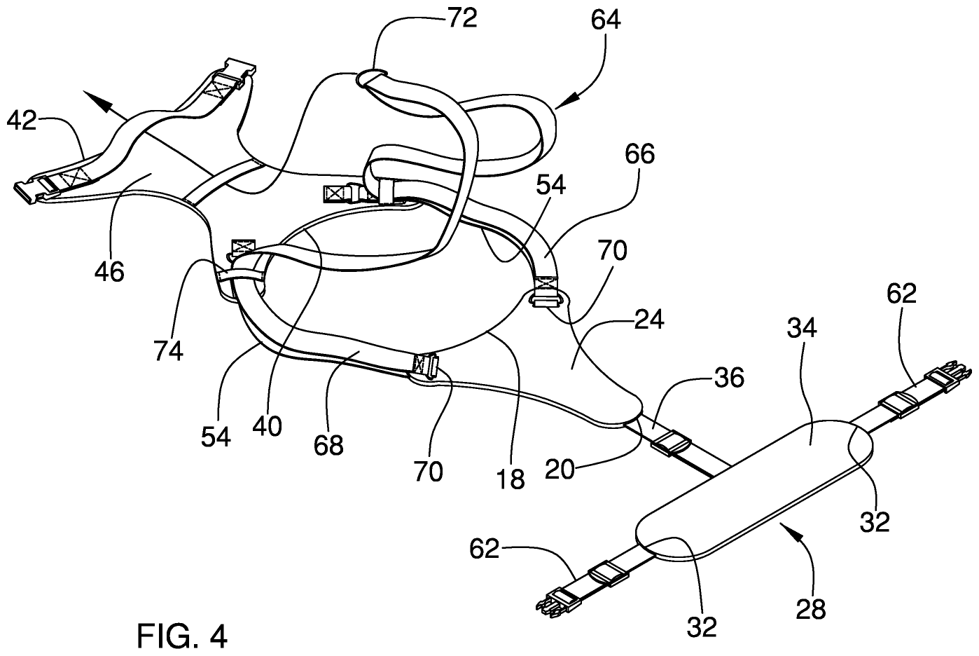

With reference now to the drawings, and in particular to FIGS. 1 through 7 thereof, a new harness device embodying the principles and concepts of an embodiment of the disclosure and generally designated by the reference numeral 10 will be described.

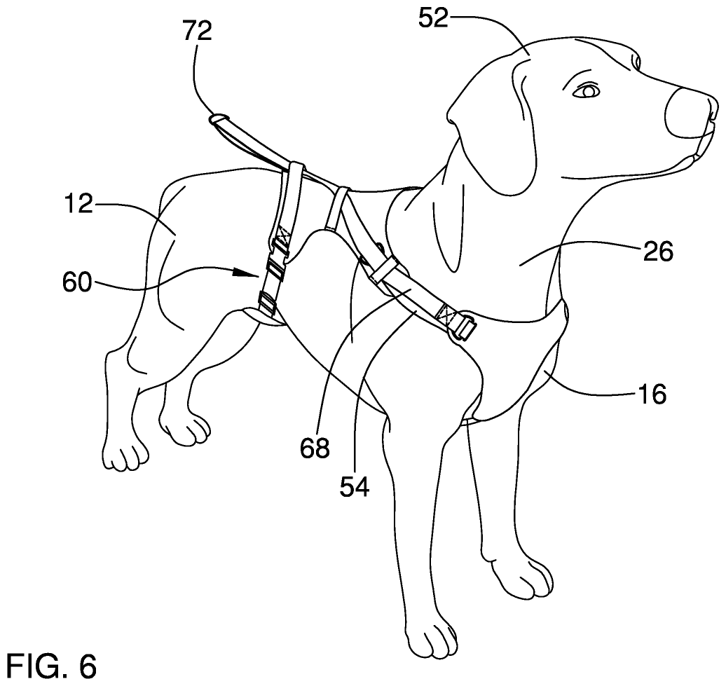

As best illustrated in FIGS. 1 through 7, the dog harness assembly 10 generally comprises an assembly 10 that will be worn by a canine, and in particular a dog 12 trained as a pet. In the descriptions below it is understood that the materials used for the assembly 10 may include strap material and cloth material and those materials are conventional to materials well known in the art of dog harnesses. The assembly 10 includes a chest section 14 for positioning on a chest 16 of the dog 12. The chest section 14 has a front edge 18, a rear edge 20 and a pair of lateral edges 22. The chest section 14 may comprise a chest panel 24 of cloth material, wherein the front edge 18 is concavely arcuate. The lateral edges 22 may taper toward each other from the front edge 18 to the rear edge 20 such that the front edge 18 has a greater length than the rear edge 20 and further the lateral edges 22 may also be concavely arcuate. This shape allows the chest panel 24 to conform to the shape of a neck 26 of the dog 12 and a space located between the dog's front legs. For clarification, the directional terms used herein will typically refer to their position when positioned and used a harness for the dog 12 as shown in FIG. 6.

A stomach section 28 may be provided for positioning on a stomach 30 of the dog 12. The stomach section 28, generally, is attached to the rear edge 18 of the chest section 14. The stomach section 28 has a pair of outer edges 32. The stomach section 28 may comprise a stomach panel 34 of cloth material that is elongated along a line extending through the outer edges 32. A stomach strap 36 extends between and connects the stomach panel 34 to the rear edge 20 of the chest panel 24. It should be understood that the stomach section 28 and the chest section 14 may be comprised of a unitary structure having wherein the stomach strap 36 comprises an extension of cloth material between the chest 24 and stomach panels 34. While the stomach section 28 is not necessary for the assembly 10 to function, the assembly 10 performance is stabilized as the stomach section 28 forms an anchor for the assembly 10, relative to the dog 12, as will be understood below.

A back section 38 has a forward end 40, a rearward end 42, and a pair of side edges 44. The back section 38 may comprise a back panel 46 of cloth material and the forward end 40 may be concavely arcuate. As can be seen in the Figures, the back panel 46 may include side edges 44 having concavely arcuate shapes and a rearward end 42 being concavely arcuate shaped. However, this shape is not essential to the functionality of the back section 38 and therefore other shapes, such as oval, may be utilized.

A coupler 48 extends between and attaches the chest 14 and back 38 sections to each other. The coupler 48 includes an opening 50 positioned between the front edge 18 and the forward end 40 to receive a head 52 of the dog 12 such that the front edge 18 is adjacent to a front of the neck 26 of the dog 12 and the forward end 40 is adjacent to a backside of the neck 26 of the dog 12. In one embodiment, the coupler 48 includes a pair of lateral straps 54. Each of the lateral straps 54 has a chest end 56 attached to the chest section 14, wherein the chest ends 56 are spaced from each other. Each of the lateral straps 54 also has a rear end 58. The rear ends 58 are attached to the back section 38 and are also spaced from each other. The lateral straps 54, the forward end 40, and the front edge 18 define a perimeter of the opening 50 through which the head 52 is extended such that the opening receives the neck 26 of the dog 12.

A connector 60 secures the stomach section 28 to the back section 38 such that the outer edges 32 extend toward opposite ends of the rearward end 42. The connector 60 comprises a pair of a side straps 62 wherein each of the outer edges 32 has one of the side straps 62 attached thereto. Each of the side straps 62 is attached to the back section 38 adjacent to the rearward end 42. The side straps 62 and lateral straps 54 may each include strap portions releasably attached together with buckles and each may further have an adjustable length to accommodate the size of the dog 12 upon which the assembly 10 is positioned.

A control strap 64 includes a first strap section 66 and a second strap section 68. Each of the first 66 and second 68 strap sections has a first end 70 attached to the chest section 14. The first ends 70 are positioned adjacent to the front edge 18 and are spaced from each other such that, as with the lateral straps 54, the neck 26 of the dog 12 is positioned between the first 66 and second 68 strap sections. A loop 72 is attached to the first 66 and second 68 strap sections distal to the first ends 70. As is shown in the Figures, the first 66 and second 68 strap sections may be formed from a single, unitary strap, however, the first 66 and second 68 strap sections may be independent of each other wherein each is secured to the loop 72 or each terminates with a separate loop. The loop 72 may comprise any conventional loop which is attachable to a walking leash 74.

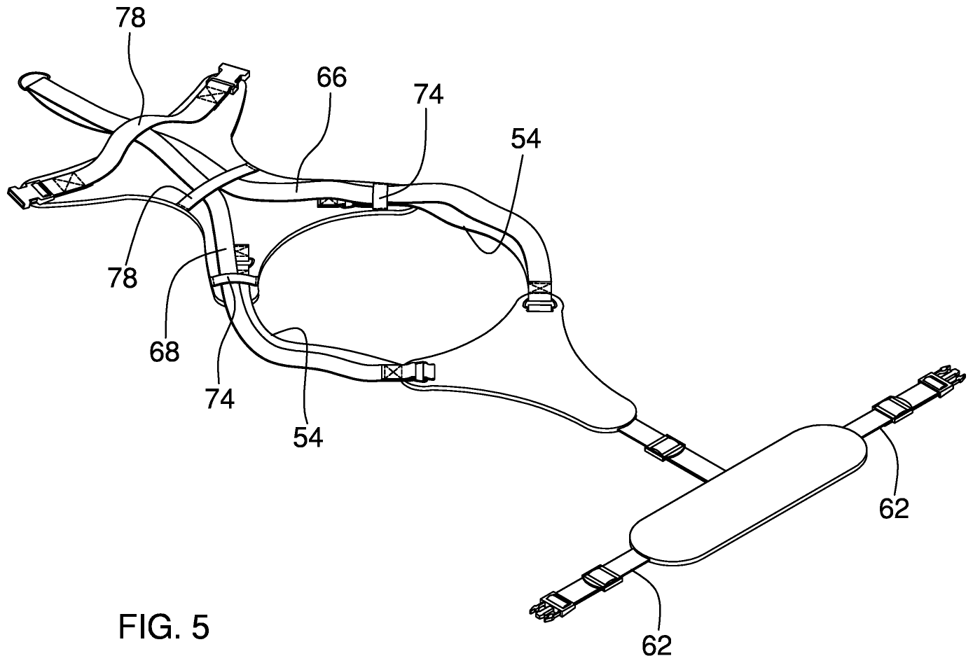

A pair of guides 74 is attached to the back section 38 adjacent to forward end 40 and are laterally spaced from each other. Each of the guides 74 has one of the first and second strap sections 66, 68 movably extending therethrough. That is, the first and second strap sections 66, 68 freely move through the guides 74 such that the front edge 18 of the chest section 14 is pulled toward the forward end 40 of the back section 38 when the loop 72 is pulled rearward of the back section 38. The guides 74 may be formed, for example, by cloth or metal loops attached to the back section. FIG. 5 depicts guides 74 each made with a strip of material having its ends secured to the back section 38 such that the first or second strap sections 66, 68 are extended between a medial portion of the strip of material and the back section 38.

A receiver 76 is attached to the back section 38 and the control strap 64 extended through the receiver 76 such that the control strap 64 is movable through the receiver 76 and the loop 72 is positioned rearward of the rearward end 42. The receiver 76 receives each of the strap sections 66, 68 to position them adjacent to each other and to stabilize the control strap 64 such that the front edge 40 properly moves toward the back section 38. The receiver 76 may comprise a pair of sleeves 78, loops, or other analogous structures being positioned on the back section 38. Each of the sleeves 78 has a passthrough for receiving the control strap 64 wherein the passthroughs of the sleeves 78 are aligned with each other along a line extending through the forward 40 and rearward 42 ends. As can be seen in Figure, the sleeve 78 adjacent to the rearward end 42 may comprise a strap having terminal ends comprising buckle mating members for releasably engaging the side straps 62. Consequently, as the control strap 64 is pulled rearwardly and upwardly, the stomach section 28 is pulled upwardly into the stomach 30 of the dog 12 to further control the dog 12.

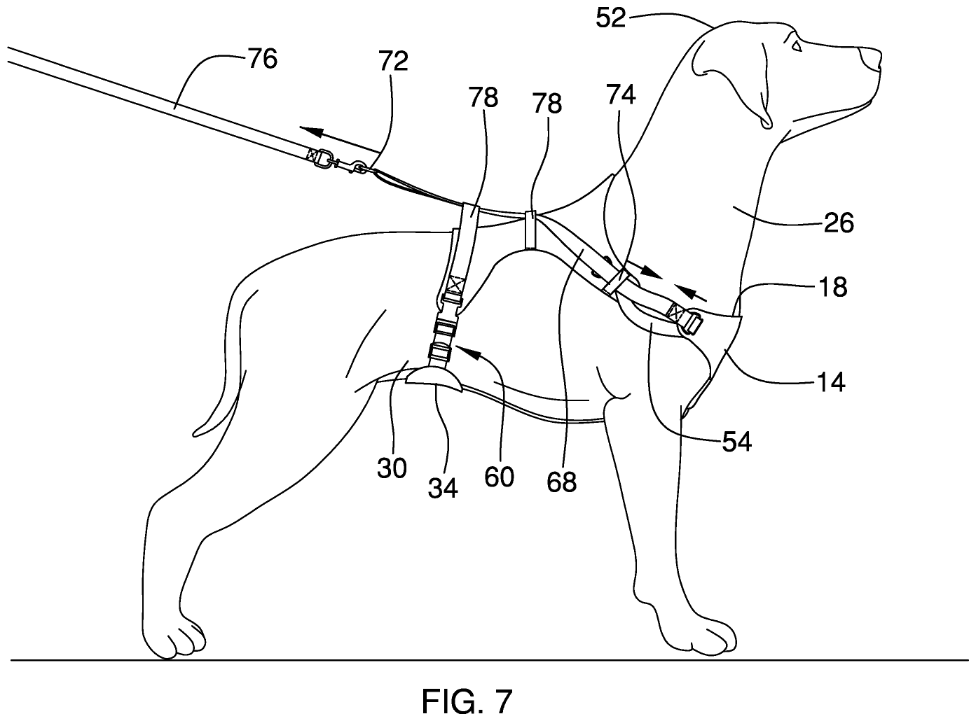

In use, the assembly 10 is positioned on the dog 12 as shown in FIGS. 6 and 7 and thereafter functions as a conventional harness. However, when the dog 12 pulls away from its handler, the control strap 64 will be pulled tight by the walking leash 74 causing the front edge 18 and forward end 40 to move together around the dog's neck 26. The dog, feeling this pressure around the neck 26, as well as against the chest 16 and stomach 30, will cease to pull strenuously on the walking leash 74, thereby providing the handler with greater control of the dog 12. Because the control strap 64 is secured to the back 38 and chest 14 sections, and because the back section 14 is secured to the stomach section 28, the force of restraint on the dog 12 is more evenly dispersed across the body of the dog 12 to prevent injury to the neck 26, when the front edge 18 and forward end 40 move toward each other, while producing an overall compression on dog's 12 body to effect movement restraint by the dog 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dog harness assembly configured for assisting with controlling a dog on a leash, the dog harness assembly comprising:
a chest section for positioning on a chest of the dog, the chest section having a front edge, a rear edge and a pair of lateral edges;
a stomach section for positioning on a stomach of the dog, the stomach section being attached to the rear edge of the chest section;
a back section having a forward end, a rearward end, and a pair of side edges;
a coupler extending between and attaching the chest and back sections to each other, the coupler including an opening positioned between the front edge and the forward end to receive a head of the dog such that the front edge is adjacent to a front of a neck of the dog and the forward end is adjacent to a backside of the neck of the dog;
a connector securing the stomach section to the back section;
a control strap including a first strap section and a second strap section, each of the first and second strap sections having a first end attached to the chest section, the first ends being positioned adjacent to the front edge and being spaced from each other such that the neck of the dog is positioned between the first and second strap sections;
a loop being attached to the first and second strap sections distal to the first ends;
a pair of guides being attached to the back section adjacent to forward end and being laterally spaced from each other, each of the guides having one of the first and second strap sections movably extending therethrough, wherein the front edge is pulled toward the forward end when the loop is pulled rearward of the back section.

2. The dog harness assembly according to claim 1, wherein the chest section comprises a chest panel.

3. The dog harness assembly according to claim 2, wherein the front edge is concavely arcuate.

4. The dog harness assembly according to claim 3, wherein the lateral edges taper toward each other from the front edge to the rear edge.

5. The dog harness assembly according to claim 1, wherein the stomach section comprises a stomach panel being elongated along a line extending through the outer edges.

6. The dog harness assembly according to claim 5, further including a stomach strap extending between and connecting the stomach panel to the rear edge of the chest panel, the stomach strap being spaced from each of the outer edges.

7. The dog harness assembly according to claim 2, wherein the stomach section comprises a stomach panel being elongated along a line extending through the outer edges.

8. The dog harness assembly according to claim 7, further including a stomach strap extending between and connecting the stomach panel to the rear edge of the chest panel, the stomach strap being spaced from each of the outer edges.

9. The dog harness assembly according to claim 7, wherein the back section comprises a back panel.

10. The dog harness assembly according to claim 9, wherein the forward end is concavely arcuate.

11. The dog harness assembly according to claim 2, wherein the back section comprises a back panel.

12. The dog harness assembly according to claim 11, wherein the forward end is concavely arcuate.

13. The dog harness assembly according to claim 7, wherein the back section comprises a back panel.

14. The dog harness assembly according to claim 1, wherein the coupler comprises a pair of lateral straps, each of the lateral straps having a chest ends attached to the chest section and being spaced from each other, each of the lateral straps having a rear end attached to the back section and being spaced from each other, the lateral straps, the forward end, and the front edge defining a perimeter of the opening.

15. The dog harness assembly according to claim 14, wherein each of the lateral straps has an adjustable length.

16. The dog harness assembly according to claim 1, wherein the connector secures the stomach section to the back section such that the outer edges extend toward opposite ends of the rearward end.

17. The dog harness assembly according to claim 16, wherein the connector comprises a pair of a side straps, each of the outer edges having one of the side straps attached thereto, each of the side straps being attached to the back section adjacent to the rearward end.

18. The dog harness assembly according to claim 1, further including a receiver being attached to the back section, the control strap extending through the receiver.

19. The dog harness assembly according to claim 18, wherein the receiver comprises a pair of sleeves being positioned on the back section, each of the sleeves having a passthrough for receiving the control strap wherein the passthroughs of the sleeves are aligned with each other along a line extending through the forward and rearward ends.

20. A dog harness assembly configured for assisting with controlling a dog on a leash, the dog harness assembly comprising:
a chest section for positioning on a chest of the dog, the chest section having a front edge, a rear edge and a pair of lateral edges, the chest section comprising a chest panel, the front edge being concavely arcuate, the lateral edges tapering toward each other from the front edge to the rear edge;
a stomach section for positioning on a stomach of the dog, the stomach section being attached to the rear edge of the chest section, the stomach section having a pair of outer edges, the stomach section comprising a stomach panel being elongated along a line extending through the outer edges, a stomach strap extending between and connecting the stomach panel to the rear edge of the chest panel;
a back section having a forward end, a rearward end, and a pair of side edges, the back section comprising a back panel wherein the forward end is concavely arcuate;
a coupler extending between and attaching the chest and back sections to each other, the coupler including an opening positioned between the front edge and the forward end to receive a head of the dog such that the front edge is adjacent to a front of a neck of the dog and the forward end is adjacent to a backside of the neck of the dog;
a connector securing the stomach section to the back section such that the outer edges extend toward opposite ends of the rearward end;
a control strap including a first strap section and a second strap section, each of the first and second strap sections having a first end attached to the chest section, the first ends being positioned adjacent to the front edge and being spaced from each other such that the neck of the dog is positioned between the first and second strap sections;
a loop being attached to the first and second strap sections distal to the first ends;
a pair of guides being attached to the back section adjacent to forward end and being laterally spaced from each other, each of the guides having one of the strap sections movably extending therethrough; and
a receiver being attached to the back section, the control strap extending through the receiver such that the control strap is movable through the receiver and the loop is positioned rearward of the rearward end, wherein the front edge is pulled toward the forward end when the loop is pulled rearward of the back section.
